(19) United States
(12) Patent Application Publication
(10) Pub. No.: US 2007/0127874 A1
(43) Pub. Date: Jun. 7, 2007

(54) Optical module with thermo-electric controller in co-axial package

(76) Inventor: Hirotaka Oomori, Yokohama-shi (JP)

Correspondence Address: SMITH, GAMBRELL & RUSSELL, 1850 M STREET, N.W., SUITE 800, WASHINGTON, DC, 20036, US

(21) Appl. No.: 11/437,000

(22) Filed: May 19, 2006

(30) Foreign Application Priority Data
May 19, 2005 (JP) 2005-147220

(51) Int. Cl. G02B 6/36

(52) U.S. Cl. 385/92; 385/93; 385/94

(57) ABSTRACT

The present invention is to provide an optical module with a co-axial package and to enable to measure the temperature of the semiconductor laser diode in accurate. The module of the present invention includes the primary portion and the package. The package has the stem and the cap mounted on the stem and covering the primary portion. The primary portion includes the thermoelectric element mounted on the stem, the sub-mount installed onto the thermoelectric element, the laser diode mounted on the sub-mount, and the resin as the shielding member fixed to the sub-mount and to thermally shield the thermistor from the cap by covering the thermistor.

### BACKGROUND OF THE INVENTION

1. Field of the Invention

The present invention relates to an optical module, in particular, the invention relates to the optical module with a thermo-electric element within a co-axial package.

2. Related Prior Arts

Two shapes of the package have been well known for the optical transmitting module installing a semiconductor laser diode. One is what is called a butterfly package with a box shape, which has disclosed in the Japanese Patent published as JP-2003-142767A. The other is what we call a co-axial package with a cylindrical shape, which has disclosed in the Japanese Patent published as JP-2003-142766A.

The former module includes a butterfly package with the box shape, a base installed within the package, a thermo-electric element arranged between the base and the package, a semiconductor laser diode (hereinafter denoted as LD) mounted on the thermo-electric element as an element to be cooled down, a lens, and a photodiode (hereinafter denoted as PD). In this module, by covering the devices mounted on the base with a thermal sheet, heat conducted from the package to the devices by the radiation may be cut, which reduces the thermal load of the thermo-electric element, thereby decreasing the power consumption.

On the other hand, the module disclosed in the latter prior art includes the thermo-electric element, the LD, and the thermistor. The LD and the thermistor are mounted on the thermo-electric element via the carrier. The LD may be controlled in the temperature thereof by the thermo-electric element within such small-sized co-axial package.

However, the module with the co-axial package, which has an advantage that the package thereof is smaller than the butterfly package, has the following subjects due to its small sized package. That is, because a distance between the thermistor and the wall of the case becomes close, the thermistor is easy to be influenced from the temperature of the case, namely, the ambient temperature of the module. Specifically, when the temperature of the LD is set to T [° C.], the thermo-electric element may be overcooled, or overheated, to the temperature (T−Δ) [° C.] because the signal output from the thermistor reflects the increase or decrease in the temperature by Δ[° C.] due to the radiation from the case. Accordingly, the LD is hard to be accurately controlled to a specific temperature.

When such module is applied to the dense wavelength division multiplexing (DWDM) system, this subject will be fatal. The emission wavelength of the LD has a temperature dependence, while, the variation of the emission wavelength of the LD is necessary to be suppressed because the span of the signal wavelengths in the DWDM system is set quite narrow. The conventional module suppresses the variation of the emission wavelength by setting a control circuit that maintains the emission wavelength of the LD constant in the outside of the module. However, such system enlarges the circuit size.

Moreover, the thermal sheet such as those used in the former document, which covers the LD together with other devices, is hard to be installed within the co-axial package. Since the co-axial package holds the lens with the case thereof, the distance between the LD and the inner surface of the case is quite small, which becomes hard to install the thermal sheet.

The present invention is to provide a module with a co-axial package and capable of precisely controlling thin temperature of the

### SUMMARY OF THE INVENTION

An optical module according to the present invention has a characteristic to provide a co-axial package, a semiconductor laser diode installed in the co-axial package, and a thermoelectric element to control the operating temperature of the laser diode. The package includes a stem and a cap fixed to the stem. The thermoelectric element is mounted on the stem, and the semiconductor laser diode is mounted on the stem. Moreover, a temperature sensor, for instance, a thermistor to monitor the temperature of the semiconductor laser diode, namely, the temperature on the thermoelectric element, is also mounted on the thermoelectric element. The first embodiment according to the present invention is that the temperature sensor is covered by the shielding member so as to be thermally isolated from the cap.

Since the temperature sensor is thermally isolated from the cap, the temperature sensor can monitor the temperature on the thermoelectric element, namely, the temperature of the semiconductor laser diode indirectly, as reducing the influence from the ambient temperature, which enables to precisely control the thermoelectric element in precise and reduces the drift of the emission wavelength of the semiconductor laser diode against the ambient temperature.

The shielding member may be an epoxy resin containing silicon dioxide (Si0₂) or aluminum nitride (AlN), and may cover the temperature sensor (thermistor) on the top of the thermoelectric element. Or, the shielding member may be a slab made of metal or ceramics fixed to the thermoelectric element and interposed between the temperature sensor and the cap. The temperature sensor, or the semiconductor laser diode, mounted on the thermoelectric element via a carrier, accordingly, the resin or the slab as the shielding member may be fixed to the carrier. Moreover, the slab may be integrally formed with the carrier.

### BRIEF DESCRIPTION OF DRAWINGS

FIG. 1 is a partially broken perspective view of the optical module according to the first embodiment of the invention;

FIG. 2 is a cross section taken along the ling II-II in FIG. 1;

FIG. 3A shows a shirt of the emission wavelength of the LD, namely, the wavelength drift, against the temperature of the LD of the optical module according to the embodiment, and FIG. 3B shows the wavelength drift without the resin;

FIG. 4 is a partially broken perspective view of the optical module according to the second embodiment of the present invention; and

FIG. 5 is a cross section of the optical module shown in FIG. 4 taken along the line V-V.

### DESCRIPTION OF PREFERRED EMBODIMENTS

Next, embodiments according to the present invention will be described in detail as referring to accompanying drawings. In the description of the drawings, same elements will be referred by the same numeral without overlapping explanations.

### First Embodiment

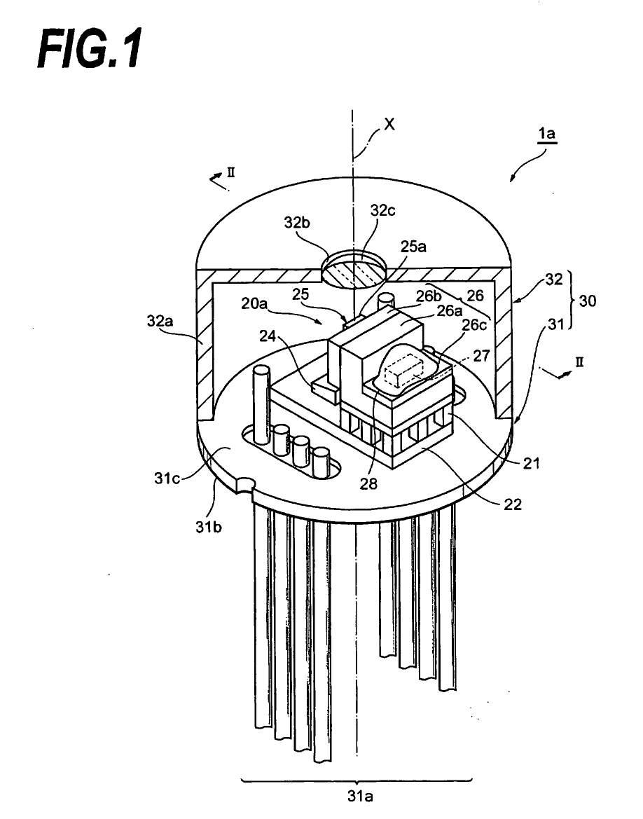

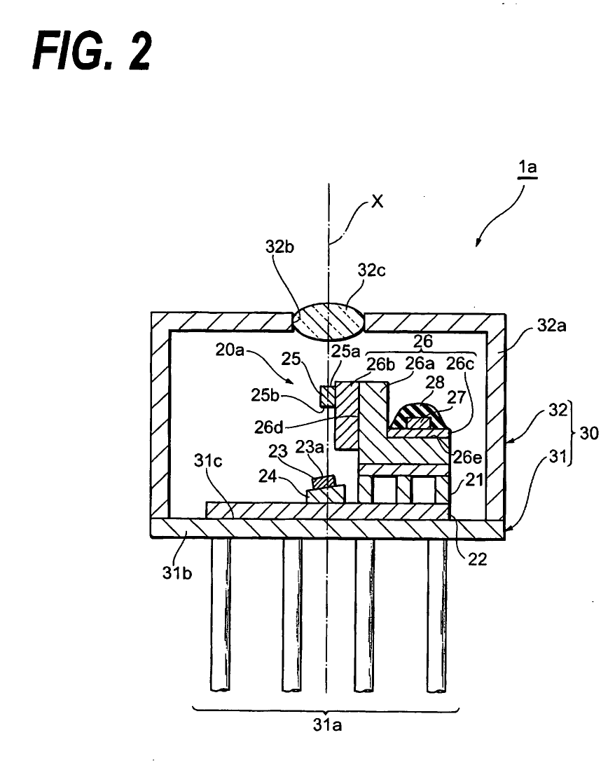

FIG. 1 is a partially broken perspective view of a module 1a according to the first embodiment of the invention. FIG. 2 is a cross section of the module 1a shown in FIG. 1 taken along the line IIT. The module 1a provides a primary portion 20a and a package 30. Here, the module 1a of the present embodiment has, what is called, a co-axial package.

The package 30 has a stem 31 and a cap 32. The stem 31 includes a plurality of lead pins 31a and a base 31b holding these lead pins 31a. The lead pin 31a extends along the axis X and, in FIG. 1, four lead pins are collectively arranged to pass the base 31b. The base 31b provides a surface 31c intersecting the axis X. On the surface 31a is mounted with the primary portion 20a that will be described later.

The cap 32 has a lens cap 32a with a cylindrical shape and a lens 32c fitted within an opening 32b of the lens cap 32a. The lens cap 32a covers the primary portion 20a and fixed in the end thereof to the surface 31c to be secured with the base 3b. The opening 32b is formed in the ceiling of the lens cap 32a. The inner circumferential surface of the opening 32b forms a holding portion of the lens. The lens cap 32a is arranged so as to position the opening 32b thereof on the optical axis of the light emitted from the LD 25. The optical beam focused by the Lens 32c is guided to the end of the optical fiber, which is not shown in the figure.

The primary portion 20a includes a plurality of thermo-electric elements 21, the supporting plate 22, the photodiode (PD) 23, the PD carrier 24, the LD25, the sub-mount 26, the thermistor 27, and the resin 28.

The thermoelectric element 21 is, what is called, a Peltier element and is arranged between the supporting plate 22 and the sub-mount 26. The plurality of thermoelectric elements 21 are serially connected to each other and the electrodes in each end are electrically connected to respective lead terminals 3la with bonding wires. The thermoelectric element 21 absorbs the heat from the supporting plate 22 where the sub-mount 26 is mounted thereon or accumulates the heat thereto. The cooling or the heating depends on the direction of the control. current. That is, the bottom plate, which supports the thermoelectric element, becomes one of the cooled or heated plates, while the other where the sub-mount 26 is mounted thereon becomes the heated or cooled plate.

The sub-mount 26 is installed on the base 31b via the thermoelectric element 21. The sub-mount 26 includes a primary carrier 26a, an LD carrier 26b, and a thermistor carrier 26c. Among them, the primary carrier 26a with an L-shaped cross section has a side surface 26d and a mounting surface 26e, refer to FIG. 2. The mounting surface 26e extends from the surface opposite to the side surface 26d in the primary carrier 26a. The primary carrier 26a is made of metal such as CuW. The LD carrier 2sb is mounted on the side surface 26d of the primary carrier 26a. The LD carrier 26b is a slab member extending along the side surface 26d and is made of insulating ceramics such as AIN. The thermistor carrier 26c is mounted on the mounting surface 26e of the primary carrier 26a. The thermistor carrier 26a is also a slab member and is made of insulating ceramics such as AlN.

The LD 25 is fixed on the LD carrier 26b. Specifically, the LD 25 is arranged on a axis identical with that of the lens 31c such that the light-emitting surface 25a and the light-reflecting surface 25b intersect the axis X, that is, the optical axis of the light emitted from the LD 25 becomes in parallel to the axis X. The anode of the LD 25 is connected to the wiring pattern formed on the LD carrier 26b with a bonding wire. Similarly, the cathode of the LO 25 is connected to the other pattern formed on the LD carrier 26b with a bonding wire. Moreover, these wiring patterns are connected to lead terminals 31a with respective bonding wires. The LD 25 emits, from the light-emitting surface 25a thereof, the coherent light corresponding to the current supplied via the lead terminals 31a.

The thermistor 27 is a device for sensing the temperature and mounted on the thermistor carrier 26c. On electrode of the thermistor 27 is directly connected to the wiring pattern formed on the thermistor carrier 26c. The other electrode thereof is also connected to the other wiring pattern on the thermistor carrier 26c. Moreover, these wiring patterns on the thermistor carrier 27 are connected to respective lead terminals 31a with bonding wires. The thermistor 27 changes its resistance depending on the temperature of the sub-mount 26, which reflects the temperature of the LD 25, and, by outputting this resistance to the outside of the module 1a via the lead terminal 31a, the temperature of the LD 25 can be detected.

The resin 28 as a shielding member is an article to absorb the thermal radiation from the lens cap 3S2a and the lens 32c to the thermistor 27. The resin 28 is stuck to the thermistor carrier 26a so as to cover the thermistor 27. The resin 28 of the present embodiment is made of resin with the good thermal conductivity. That is, the resin 28 adds thermal conductive materials such as silica (SiO₂) as the filler to an epoxy resin. For the filler except the silica, the aluminum nitride is well known. The thermal conductivity of the resin 29 is preferable to be greater than 1.0 W/m/K.

The PD 23 is a device to detect the emission intensity of the LE) 25, The PD 23 has light-receiving surface 23a that optically couples with the light-emitting surface 25b of the LD 25. One electrode of the PD 23 is directly connected to the PD carrier 24. The PD carrier 24 is connected to the lead terminal 31a with a bonding wire. But, the other electrode of the PD 23 is connected to another lead terminal 31a with a bonding wire. The PD 23 outputs a current, which corresponds to the intensity of the backlight emitted from the light-reflecting surface 25b of the LD 25, to the outside of the module 1a via the lead terminal 31a.

The PD carrier 24 is mounted on the supporting plate 22. The surface of the PD carrier 24 is beveled to the axis X and the PD 23 is mounted on this beveled surface. Thus, the backlight of the LD 25 reflected by the light-receiving surface 23a of the PD may be prevented from returning the LD 25 to cause a noise source within the LD 25.

Here, similar to the present embodiment, the PD 23 is preferable to be mounted on the supporting plate 22 not on the thermo-electric element 21. In general, the temperature dependence of the optical sensitivity of the PD is far small compared to that of the LD under the room temperature condition between −40° C. to 85° C. Accordingly, the PD 23 is unnecessary to be mounted on the thermo-electric element, thus, the heat capacity of the members mounted on the thermo-electric element 21 may be reduced.

When the LD is operated, the current supplied to the thermoelectric element is controlled in the magnitude and the direction thereof such that the resistivity of the thermistor approaches a value corresponding to the target temperature. For example, the target temperature is set for 40° C., the resistivity of the thermistor may be maintained to a value corresponding to 40° C. by constituting a feedback loop to supply the control current, which is derived from the difference between the reference corresponding to 40° C. and the signal based on the resistivity of the thermistor, to the thermoelectric element.

When the ambient temperature of the module increases to, for example, 75° C., which raises the case temperature and causes the heat radiation from the case to the thermistor. Accordingly, the temperature that the thermistor practically senses becomes 40+α [° C.] by adding the contribution α [° C.] of the radiation. Therefore, to control the current in the magnitude and the direction thereof supplied to the thermoelectric element to maintain the resistivity of the thermistor to the value corresponding to 40° C. inevitably results in the excess cooling by α [° C.]. Due to this control, the emission wavelength of the LD is lengthened by A×α [nm], where A is a correlation coefficient between the temperature and the wavelength shift, from the wavelength the LD is necessary to emit. on the other hand, when the ambient temperature falls, the practical temperature that the thermistor senses becomes, by reducing the contribution P of the radiation, 40−β [° C.]. Therefore, the feedback control mentioned above results in the overheating by β [° C.], which shortens the emission wavelength of the LD by A×β [nm] from the wavelength the LD is necessary to emit.

The heat radiation from the case to the thermistor strongly depends on the gap therebetween. The gap between the thermistor and the case is ensured about 3 mm in the case of the butterfly package. on the other hand, the co-axial package generally ensures only from 0.2 mm to 0.5 mm. The reason is that the butterfly package has about 10 mm square in the case size thereof, while, the co-axial package in the size thereof has a small diameter from 3 to 5 mm. Moreover, in the co-axial package the lens cap 32a that holds the lens 32c comprises a portion of the package 30, and the LD 25 is necessary to position close to the focal point of the lens 32c, which inevitably makes the LD 25 close to the cap 32.

The module 1a according to the present embodiment, the resin 28 may absorb the heat radiation from the cap 32 to the thermistor 27. Moreover, because the resin 23 is stuck to the thermistor carrier 26c, the resin 28 may be cooled down by the thermoelectric element 21. Accordingly, the resistivity of the thermistor is hard to be affected from the ambient temperature of the module la, namely, from the temperature of the cap, the LD may be precisely controlled in the temperature thereof.

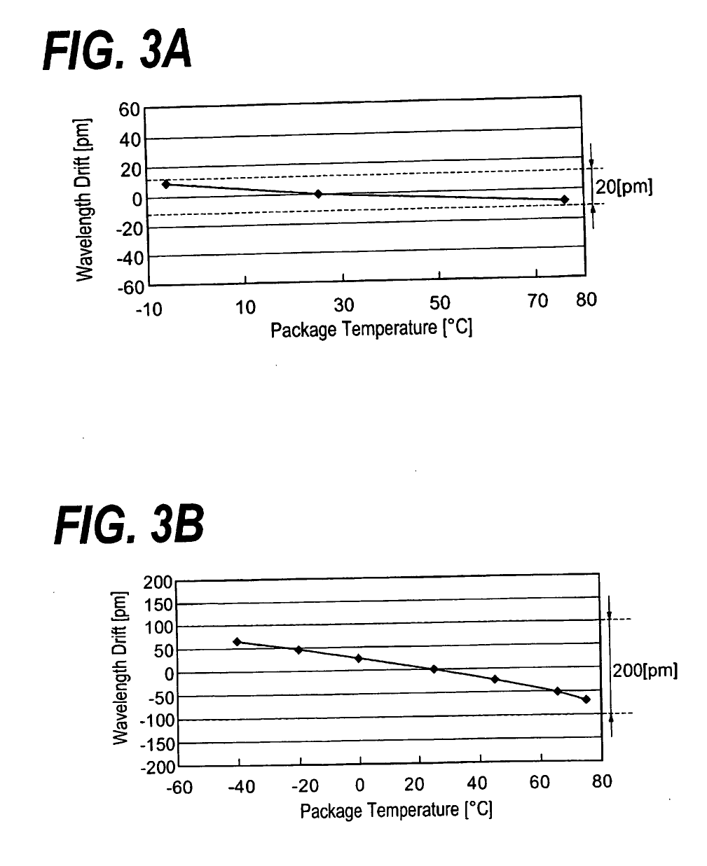

FIG. 3A shows a relation between the temperature of the package 30 and the shift in the emission wavelength of the LD 25, which is called as the wavelength drift. FIG. 3B shows the relation between the temperature of the package and the wavelength drift without the resin 28. These data are measured under a condition that the driving current of the LD 25 is set 40 [mA] and the current for the thermoelectric element is controlled in the magnitude and the direction thereof such that the resistivity of the thermistor 27 keeps the value corresponding to the 40 [° C.].

As shown in FIG. 3A, in the module 1a according to the present embodiment, the wavelength drift may be converged within 20 [pm] in the temperature range or the package 30 from −10 [° C.] to 80 [° C.] . While, in the case without resin 28 shown in FIG. 3B, the wavelength drift of about 200 [pm] is observed in the temperature range of the package 30 from −40 [° C.] to 80 [° C.]. Thus, the module 1a according to the present embodiment, the temperature of the LD 25 may be precisely controlled within a vicinity of the target temperature and the wavelength drift of the emission may be reduced.

Moreover, as described, the module having a co-axial package similar to that of the present embodiment is hard to arrange the structure where whole parts to be cooled down are covered because the gap between the LD and the case is quite narrow. For such situation, the module 1a of the present embodiment covers only the thermistor 27 by the resin 28. Therefore, the resin may become small as compared to the aforementioned thermal sheet, which may reduce the heat capacity of the members mounted on the thermoelectric element. In the present embodiment, although the resin 28 fully covers the thermistor 27, the resin may cover a portion of the thermistor 27 where the resin at least couples in thermal to the sub-mount 26 and positions between the thermistor 27 and the cap 32. Moreover, in the present embodiment, the sub-mount 26 has the LD carrier 26b and the thermistor carrier 26c and the LD 26 and the thermistor 27 are independently mounted on each carrier, but the LD and the thermistor may be mounted together on the signal carrier.

Moreover, in the manufacturing of the present module 1a, the resin 29 encapsulates the thermistor 27 and the bonding wire on the thermistor carrier 26c after the thermistor 27 is soldered onto the thermistor carrier 26c and is wire-bonded thereto after the die-bonding. Subsequently, this assembly is mounted on the mounting surface 26e of the primary carrier 26a and is wire-bonded to the lead terminals 31a, thus, the assembly around the thermistor 27 may be simply carried out.

### Second Embodiment

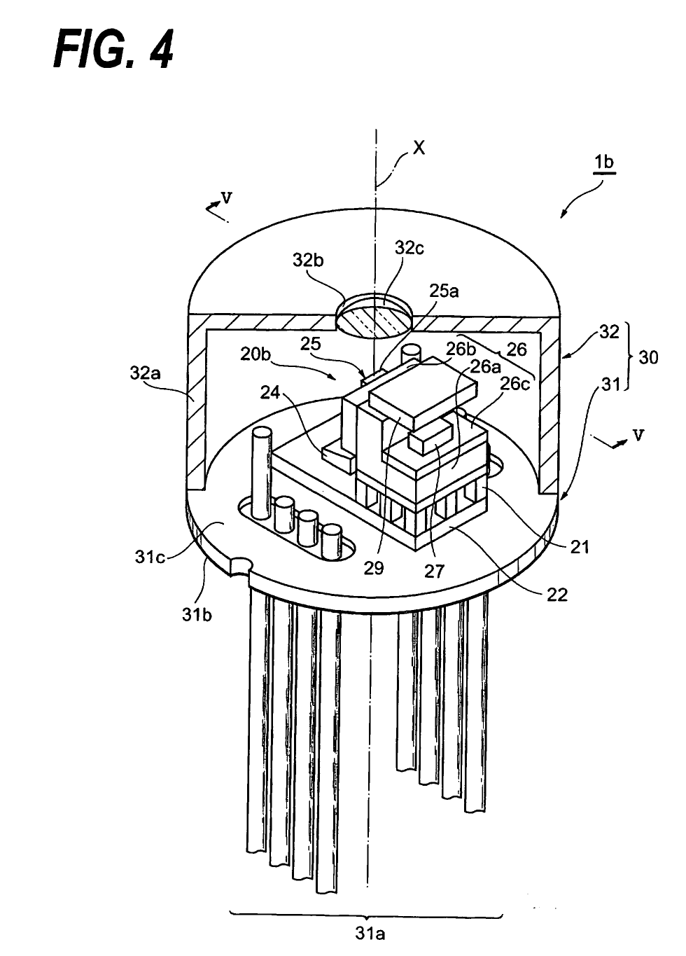

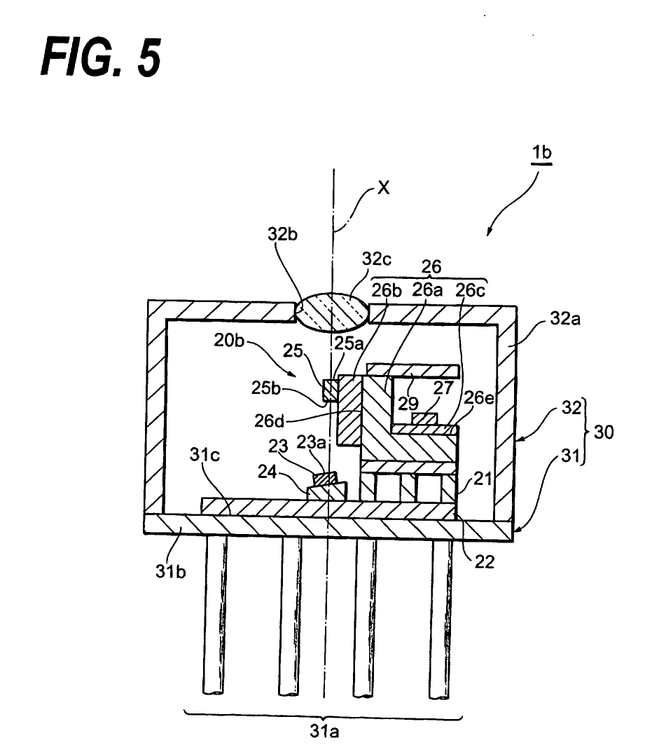

FIG. 4 is a partially broken perspective view of the module 1b according to the second embodiment. FIG. 5 is a cross section of the module 1b taken along the line V-V shown in FIG. 4. Differences of the module 1b according to the present embodiment and the module 1a of the first embodiment are that the module 1b of the present embodiment provides a slab 29 as the shielding member instead of the resin 28 of the first embodiment. The explanations of the arrangement except for the slab 29 are omitted because those are the same as the first embodiment.

The primary portion 20b in the module 1b has the slab 29. The slab 29, positioned between the thermistor 27 and the cap 32, shields the heat radiation from the cap 32 to the thermistor 27. Specifically, the slab 29 is fixed in one end thereof to the upper end surface of the primary carrier 26a, which faces the wall of the lens cap 32a. The slab 29 extends from the upper end of the primary carrier 26a to protrude between the wall of the cap 32 and the thermistor 27. The thickness of the slab 29 is, for example, 0.1 mm.

The slab 29 is preferably a metal sheet made of, for example, aluminum and copper, or a metal film. Or, except for metal, the slab 29 may be made of ceramics with good thermal conductivity such as aluminum nitride. When the slab 29 is non-metallic, the surface of the slab 29 in an end portion thereon is formed with a metal pattern, and the primary carrier 26a made of metal and the non-metallic slab 29 may be connected via this metallic pattern.

The module 1b of the present embodiment shields the heat radiation from the cap 32 to the thermistor 27 by the slab 29. Moreover, the slab 29 is cooled down by the thermoelectric element 21 because the slab 29 is fixed to the primary carrier 26a. Therefore, similar to the module 1a according to the first embodiment, the resistivity of the thermistor is hard to be affected by the ambient temperature of the module 1b, which enables to accurately monitor the temperature of the LD. Furthermore, by controlling the current supplied to the thermoelectric element 21 in the magnitude and the direction thereof based on the resistivity of the thermistor 27, the temperature of the LD 25 may be precisely controlled to reduce the wavelength drift.

The module according to the present invention is not restricted in the configuration thereof to the embodiments above described, and various modifications way be considered. For example, the resin in the first embodiment may be replaceable by various materials except for the epoxy resin. The slab in the second embodiment, which is arranged between the wall of the cap and the thermistor, may be positioned between the side of the cap and the thermistor. Or, the slab of the present invention may fully cover the thermistor. Moreover, the slab is described as independent of the primary carrier 26a, but the slab may be a metal member integrally formed with the primary carrier 26a or the LD carrier 26b.

What is claimed is:

1. An optical module, comprising:
a co-axial package including a stem and a cap fixed to the stem; and
a primary portion mounted on the stem, the primary portion including,
a thermoelectric element,
a semiconductor laser diode mounted on the thermoelectric element, and
a temperature sensor mounted on the thermoelectric element and monitoring a temperature of the semiconductor laser diode,
wherein the temperature sensor is thermally coupled with the thermoelectric element and covered by a shielding member that thermally shields the temperature sensor from the cap.

2. The optical module according to claim 1,
wherein the shielding member is a resin.

3. The optical module according to claim 2,
wherein the resin is an epoxy resin containing at least one of silicon dioxide and aluminum nitride.

4. The optical module according to claim 2,
wherein the shielding member has the thermal conductivity of at least 1 W/m/K.

5. The optical module according to claim 1,
wherein the shielding member is a slab made of metal or ceramics.

6. The optical module according to claim 1,
wherein the semiconductor laser diode and the temperature sensor is mounted on the thermoelectric element via a sub-mount.

7. The optical module according to claim 5,
wherein the shielding member is a slab made of metal or ceramics fixed to the sub-mount.

8. An optical module having a co-axial package with a stem and a cap fixed to the stem, and a thermoelectric element mounted on the stem, comprising:
a sub-mount mounted on the thermoelectric element;
a semiconductor laser diode mounted on the thermoelectric element;
a temperature sensor mounted on the sub-mount for monitoring a temperature of the semiconductor laser diode;
a shielding member thermally coupled with the sub-mount and positioned between the temperature sensor and the cap,
wherein the shielding member thermally shields the temperature sensor from the cap.

9. The optical module according to claim 8,
wherein the sub-mount includes a primary carrier and another carrier, the other carrier mounting the temperature sensor thereon and
wherein the shielding member is a resin fixed to the other carrier.

10. The optical module according to claim 8,
wherein the sub-mount includes a primary carrier and another carrier mounted on the primary carrier, the other carrier mounting the temperature sensor thereon, and
wherein the shielding member is a slab made of metal or ceramics and fixed to the other carrier.

11. The optical module according to claim 8,
wherein the sub-mount includes a metallic primary carrier, and
wherein the shielding member is a metallic member integrally formed with the primary carrier.
